(19) United States
(12) Patent Application Publication
(10) Pub. No.: US 2018/0021732 A1
(43) Pub. Date: Jan. 25, 2018

(54) MEMBRANE ASSEMBLY WITH END CAP DEVICE AND RELATED METHODS

(71) Applicant: Nanostone Water Inc., Eden Prairie, MN (US)

(72) Inventors: Paul Osmundson, Eden Prairie, MN (US); Christopher James Kurth, Eden Prairie, MN (US)

(73) Assignee: Nanostone Water Inc., Eden Prairie, MN (US)

(21) Appl. No.: 15/540,957

(22) PCT Filed: Jan. 6, 2016
(86) PCT No.: PCT/US2016/012366

§ 371 Date: Jun. 29, 2017

Related U.S. Application Data
(60) Provisional application No. 62/100,407, filed on Jan. 6, 2015.

(51) Int. Cl. B01D 65/00; B01D 63/08; B01D 71/02

(52) U.S. Cl. CPC B01D 65/003; B01D 71/02; B01D 63/082; B01D 2313/08; B01D 2313/21; B01D 2319/04; B01D 2313/025

(57) ABSTRACT

A filtration assembly includes at least one membrane assembly, where the membrane assembly includes a membrane and at least one end cap device. The end cap device is defined in part by a longitudinal axis and extends from a first end to a second end along the longitudinal axis. The end cap device includes an intermediate profile between the first end and the second end, and the second end has a smaller inner diameter than the first end.

### PRIORITY CLAIM

This application claims priority to U.S. Provisional Application No. 62/100,407 that was filed on 6 Jan. 2015. The entire content of this provisional application is hereby incorporated herein by reference.

### TECHNICAL FIELD

The present embodiments relate to a membrane assembly with end cap device and related methods.

### BACKGROUND

In the process of manufacturing filtration module assemblies, the assemblies can experience large range of temperatures which can affect the individual components within the assembly and their performance in the field. In addition, the filtration assembly has important sealing requirements which can also be affected during assembly. Still further, once a membrane assembly is potted, the membrane must be scrapped if it fails during testing. Additionally, the sizing of the membranes can vary widely. What is needed is an improved method of manufacture of filtration assemblies.

### SUMMARY

A filtration assembly includes a ceramic membrane assembly configured to be disposed within the housing, where the membrane assembly includes a membrane and at least one end cap device. The end cap device is defined in part by a longitudinal axis and extends from a first end to a second end, where an inner surface of the end cap device has a domed shape at the intermediate profile, and the second end of the end cap device has a smaller inner diameter than the first end.

### BRIEF DESCRIPTION OF THE DRAWINGS

In the detailed description of the embodiments presented below, reference is made to the accompanying drawings, in which:

FIG. 1A illustrates a side and cross-section view of a filtration assembly in accordance with one or more embodiments.

FIG. 1B illustrates a cross-sectional view of a filtration assembly in accordance with one or more embodiments.

FIG. 2A illustrates a side view of a membrane assembly in accordance with one or more embodiments.

FIG. 2B illustrates an end view of a membrane assembly in accordance with one or more embodiments.

FIG. 2C illustrates a cross-sectional view of a membrane assembly in accordance with one or more embodiments.

FIG. 2D illustrates a cross-sectional view of a membrane assembly in accordance with one or more embodiments.

FIG. 3A illustrates a side view of a membrane assembly in accordance with one or more embodiments.

FIG. 3B illustrates an end view of a membrane assembly in accordance with one or more embodiments.

FIG. 3C illustrates a cross-sectional view of a membrane assembly in accordance with one or more embodiments.

FIG. 4A illustrates a first cross-sectional view of an end cap device in accordance with one or more embodiments.

FIG. 4B illustrates a top view of an end cap device in accordance with one or more embodiments.

FIG. 4C illustrates a side view of an end cap device in accordance with one or more embodiments.

FIG. 4D illustrates a second cross-sectional view of an end cap device in accordance with one or more embodiments.

FIG. 4E illustrates a bottom view of an end cap device in accordance with one or more embodiments.

FIG. 5A illustrates a cross-sectional view of an end cap device in accordance with one or more embodiments.

FIG. 5B illustrates a top view of an end cap device in accordance with one or more embodiments.

FIG. 5C illustrates a side view of an end cap device in accordance with one or more embodiments.

FIG. 5D illustrates a bottom view of an end cap device in accordance with one or more embodiments.

FIG. 5E illustrates a bottom view of an end cap device in accordance with one or more embodiments.

FIG. 6A illustrates a bottom view of an end cap device and a fixture device in accordance with one or more embodiments.

FIG. 6B illustrates a cross-sectional view of the end cap device and the fixture device taken along 6B-6B of FIG. 6A, in accordance with one or more embodiments.

FIG. 7 illustrates a cross-section view of an end cap device in accordance with one or more embodiments.

FIG. 8 illustrates a cross-section view of an end cap device in accordance with one or more embodiments.

The present embodiments are detailed below with reference to the listed figures.

### DETAILED DESCRIPTION OF THE EMBODIMENTS

In the following detailed description, reference is made to the accompanying drawings which form part of the description, and in which is shown by way of illustration specific embodiments in which the embodiments may be practiced. These embodiments are described in sufficient detail to enable those skilled in the art to practice the invention, and it is to be understood that other embodiments may be practiced in other ways. The following detailed description is not to be taken in a limiting sense, and the scope of the invention is defined by the appended claims and their equivalents.

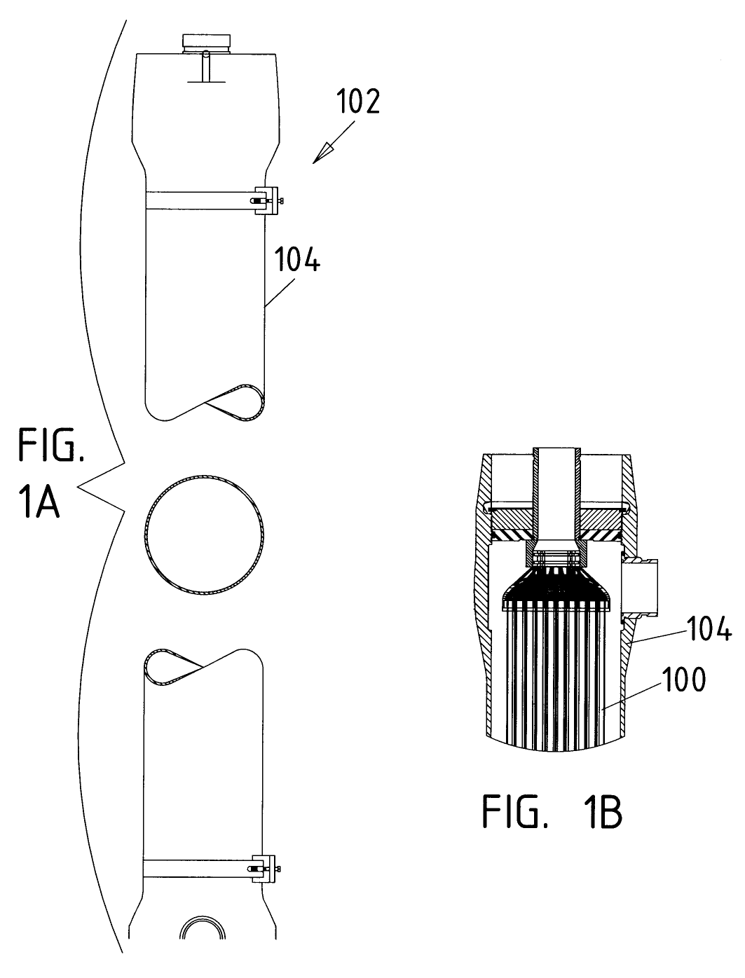

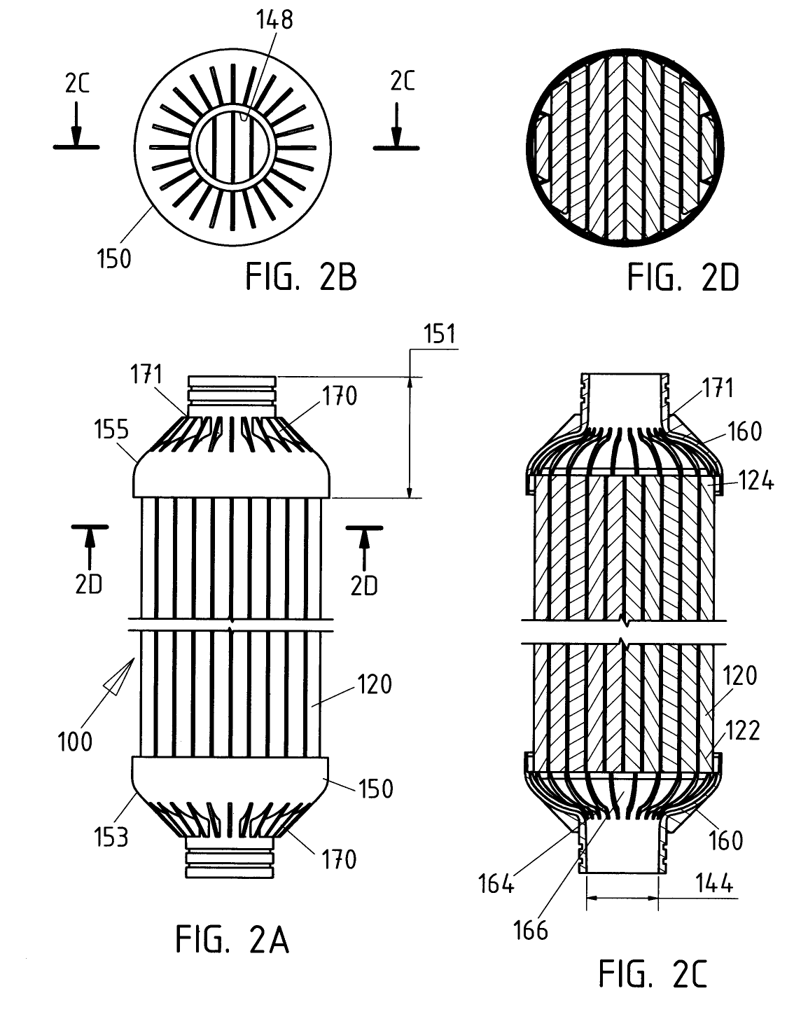

The present embodiments relate to a filtration assembly 102, as shown in FIGS. 1 and 2. The filtration assembly 102 includes a housing 104, and a membrane assembly 100 within the housing 104. The filtration assembly 102 can be used to treat fluids such as waste or water in a water treatment plant. The filtration assembly 102 can be loaded in a basin, used for membrane bioreactor, used for waste affluence, or used in other applications.

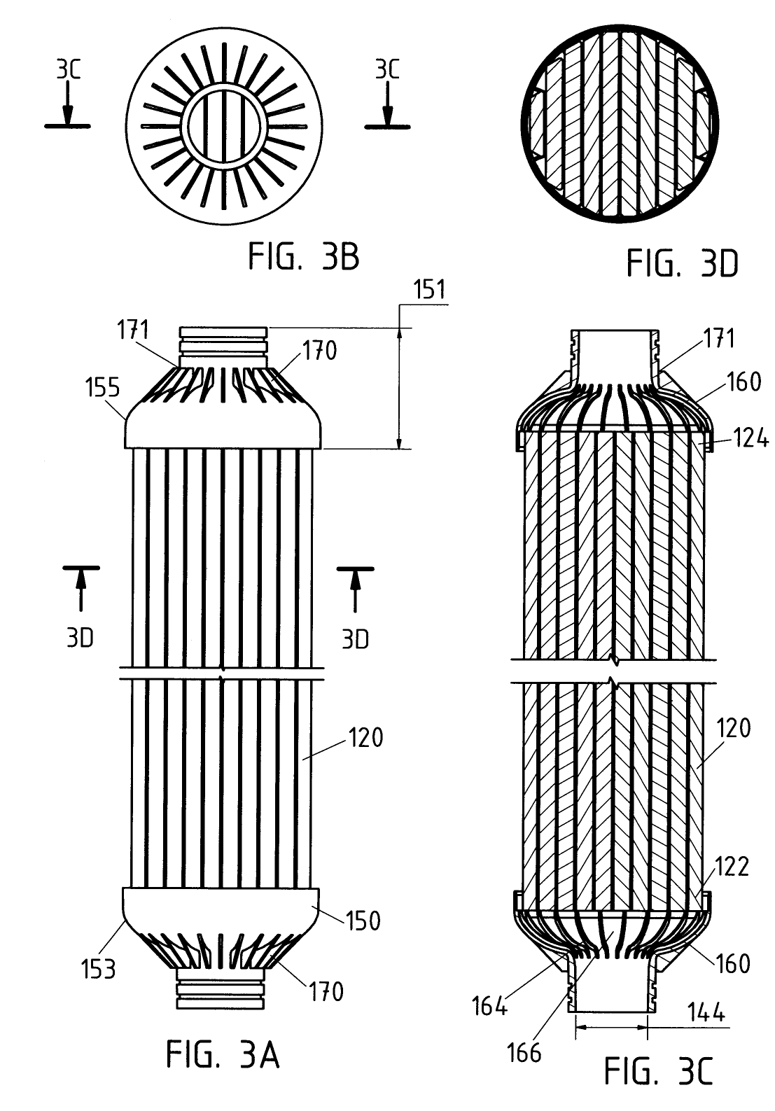

In one or more embodiments the filtration assembly 102 includes at least one membrane assembly 100, where the membrane assembly 100 includes at least one membrane 120 and at least one end cap device 150 (See FIGS. 2A-2D, 3A-3C). In one or more embodiments, the membrane 120 is a ceramic membrane. The membrane 120 extends from a first membrane end 122 to a second membrane end 124. The membrane 120 includes two or more membrane channels therein.

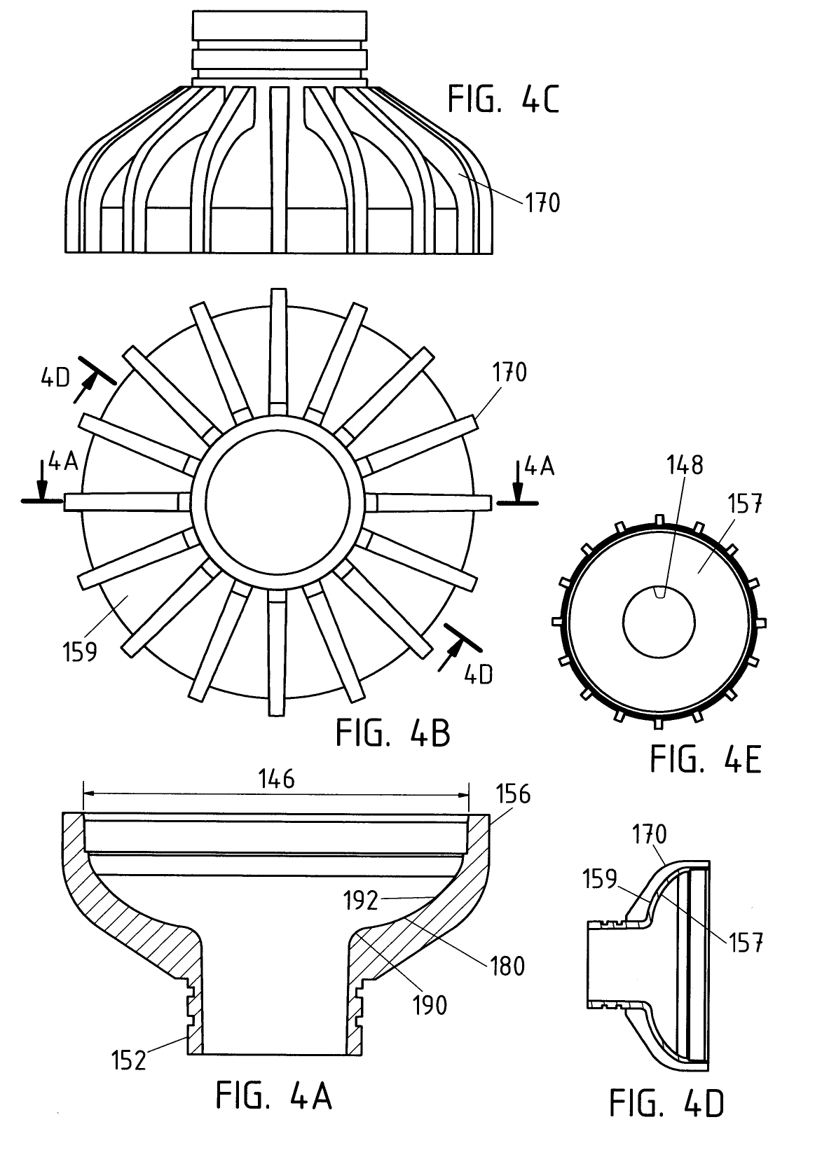

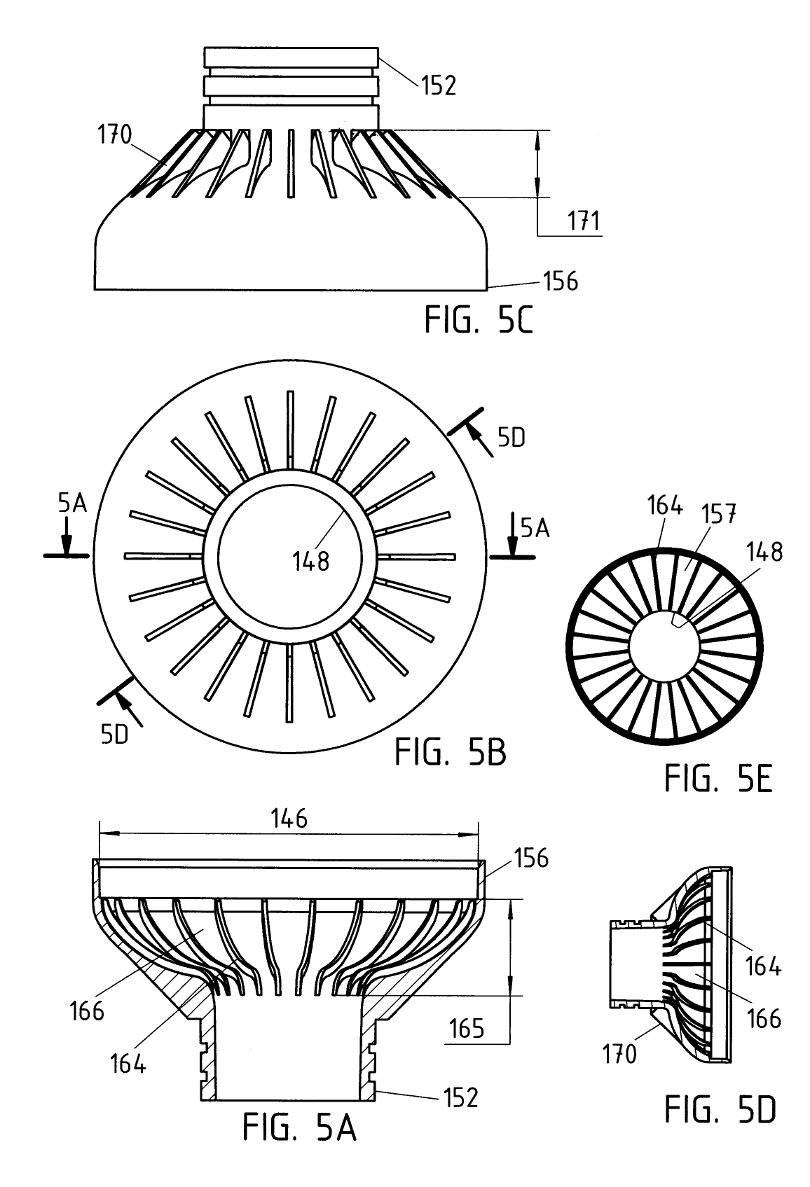

The membrane assembly 100 further includes at least one end cap device 150, for example, disposed at the first membrane end 122. In one or more embodiments, the membrane assembly 100 includes two end cap devices, including a first end cap device 153 and a second end cap device 155 disposed at the first membrane end 122 and the second membrane end 124, respectively. Referring to FIGS. 4A-4E, 5A-5D, the end cap device 150 is defined in part by a longitudinal axis and extends from a first end 152 to a second end 156 along the longitudinal axis. At the first end 152 is a neck that serves as an inlet or outlet port 148 for the membrane assembly 120. The second end 156 is sized to couple with the membranes. In one or more embodiments, the membrane 120 and the end cap device 150 form a water tight seal to the end of the membrane channels. In one or more embodiments, there is a water tight seal formed inside the end cap device at the second end 156, between the end cap device and the membrane 120. In one or more embodiments, a water tight seal is formed at an exterior surface of the first end 152 of the end cap device. A combination of these seals isolates the clean water from the dirty water within the filtration assembly.

In one or more embodiments, the first end 152 has a smaller outer diameter than the second end 156. For example, in one or more embodiments the first end 152 has an inner diameter, a first diameter 144, of about 3 inches and the second end has an inner diameter, a second diameter 146, of about 8 inches. In one or more embodiments, the first end 152 has a diameter of 3-3.5 inches and the second end has a diameter of about 8 inches. The end cap device 150 is further defined by an overall length L, shown as 151 on FIGS. 2A and 3A. The end cap device is defined in part by an inner diameter D at the second diameter 146, as shown in FIG. 4A. In one or more embodiments, a general range of the ratio of L to D, is as follows:

L/D=1.5-5.1

In one or more embodiments, R is inner radius of the feed or concentrate nozzle in inches, shown as 144 in FIG. 2C, where R is a radius of a smallest outlet of the end cap device. In one or more embodiments, r is an amount of recess of the membrane within the housing, and r is a recess in inches, where r is measured from the outlet of the end cap device to the face of the membrane. Q is flow of the feed solution through the membrane in GPM. To determine the recess for the membrane relative to the housing, test data was developed. According to the test data, the minimum recess can be determined, as follows.

| R ≧ | Q ≧ | r ≧ |
|---|---|---|
| radius | flow | recess |
| (inches) | (gpm) | (inches) |
| 2 | 300 | 2.293829 |
| 1.5 | 300 | 3.018439 |
| 1 | 300 | 4.527958 |
| 0.5 | 300 | 9.055319 |
| 2 | 100 | 0.75491 |
| 1.5 | 100 | 1.009149 |
| 1 | 100 | 1.509219 |
| 0.5 | 100 | 3.018439 |
| 2 | 200 | 1.509219 |
| 1.5 | 200 | 2.012292 |
| 1 | 200 | 3.018439 |
| 0.5 | 200 | 9.039877 |

In one or more embodiments the minimal recess distance for any flow and inlet radius can be calculated through the use of the following equation:

r≧Q/(132*R).

In one or more embodiments, the minimal recess distance for any flow and inlet radius can be calculated through the use of the following equation:

r≧Q/(66*R).

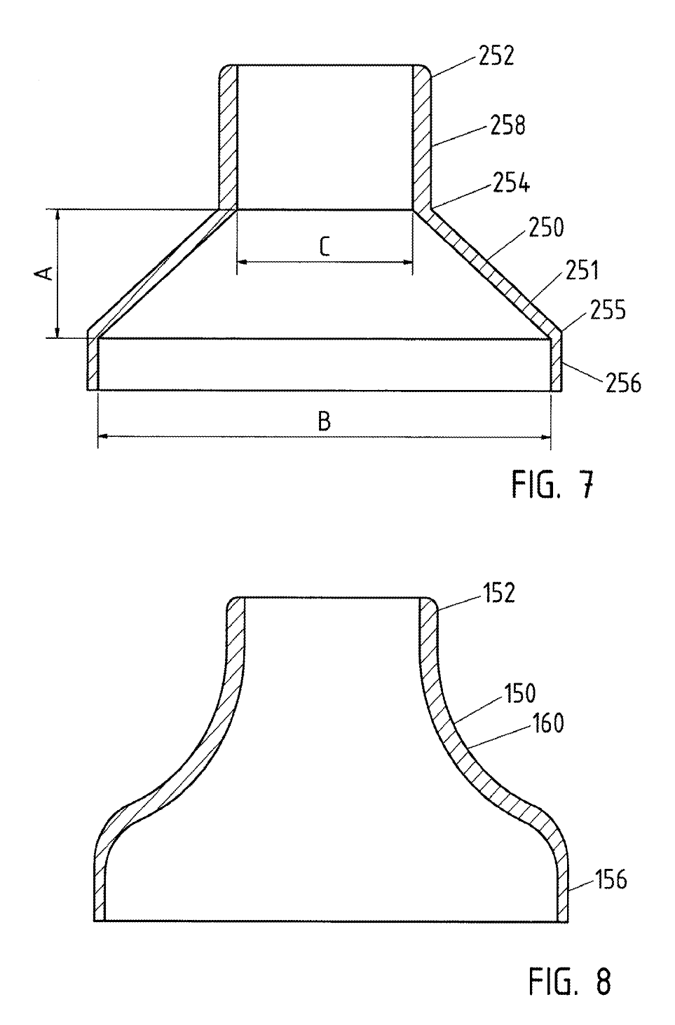

The end cap device 150 is further defined by an inner surface 157 and an outer surface 159, and an intermediate profile 160 between the first end 152 and the second end 156. In one or more embodiments, the intermediate profile 160 of the inner surface 157 is inflective, or curved, three of more sided pyramid, or has a funnel shape. In one or more embodiments, the end cap device 150 has a bell shape that extends from a first end 152 to a second end 156, as shown in FIG. 8. In one or more embodiments, the inner surface 157 of the intermediate profile 160 has a domed shape, such that the shape is a hemisphere or a having a concave surface toward the membranes 120. In a further option, the intermediate profile further includes an inflective curve that transitions the domed shape to the second end 156 of the end cap device 150. In one or more options, the end cap device 150 includes an inflection portion 180 between the first end and the second end, where the inflection portion 180 that transitions between the concave dome to the first end 152 at the exit port. In one or more embodiments, the inflection portion connects the first end 152 to the second end 156. In one or more embodiments, the end cap device 150 includes a first radius 190 near the first end 152, and a second radius 192 near the second end 146, and the first radius is not equal to the second radius.

In one or more embodiments, an outer intermediate profile is different than an inner intermediate profile. For instance, the wall thickness varies along the intermediate profile. In one or more embodiments, as the diameter between the first and second end changes, the size of the end port will change in relative proportions. For example, if a nominal 8 inch diameter of the end cap device is 8 inches, and the end port is 3.5 inches, and when going to a 4 inch diameter, the cross sectional area of the cap would stay in relative proportion to the outlet port cross sectional area. This will assist with fluid flow properties and proper delivery of the fluid.

Referring to FIG. 7, in one or more embodiments, the end cap device 250 extends from a first end 252 to a second end 256. At the first end 252 is a neck portion 258. At an intermediate portion 251 is a conical shape, extending from a first conical end 254 to a second conical end 255. The conical shape has a height A, extending from the first conical end 254 to the second conical end 255. At the first conical end 254 is an inner diameter C, and at the second conical end 255 is an inner diameter B, as shown in FIG. 7.

In one or more embodiments, the end cap device 250 is sized as follows:

(B²/C²)*6x≈A, where x≧1.

The end cap device 150 includes a sealing portion 210 which allows for universal sealing within a filtration device, and allows for the membrane assembly to be easily moved from one housing to another. In one or more embodiments, the end cap device 150 includes at least one groove 212 with a sealing element therein. In one or more embodiments, the sealing element includes an elastomer, or an O ring. This allows for the seals to be removed or interchanged. In one or more embodiments, the sealing portion is disposed on an interior portion of the end cap device 150, and the membrane 120 is disposed within the end cap device 150. In one or more embodiments, the sealing portion 210 is disposed on an exterior portion of the end cap device 150.

In one or more embodiments, the end cap device 150 further includes one or more ribs 170 disposed on an exterior portion along the outer surface 159, for example along the intermediate profile 160. The one or more ribs 170 can be used to stabilize the structure of the end cap device 150 against the forces of the fluid throughout the membrane assembly. In one or more embodiments the fins extend from a neck of the end cap device 150 to the second end 156, as shown in FIG. 4C. In one or more embodiments, the ribs 170 extend from the neck 171 of the end cap device 150, but not fully to the second end 156, as shown in FIG. 5C. For example, the ribs terminate in between the neck 171 and the second end 156. The ribs add strength without adding wall thickness, and can further assist with fluid flow.

In one or more embodiments, the end cap device 150 optionally further includes one or more inner fins 164 disposed along the inner surface of the end cap device, where the inner fins have flow channels 166 therebetween. In one or more embodiments, the fins 164 are defined by a height 165. In one or more embodiments, the ribs 170 ribs are offset from the fins 164, such that they are not in alignment on the end cap device 150. In one or more embodiments, a total number of fins 164 is half to two times a total number of ribs 170. The fins add Strength without adding wall thickness, and can further assist with fluid flow.

In one or more embodiments, the end cap device can be affixed and sealed to an outer perimeter of a monolithic multi-bore ceramic module. In another embodiment, the end cap device can be molded in one or more numbers of discrete pieces to both pot the membrane segments together and create a collection chamber for the feed and concentrate.

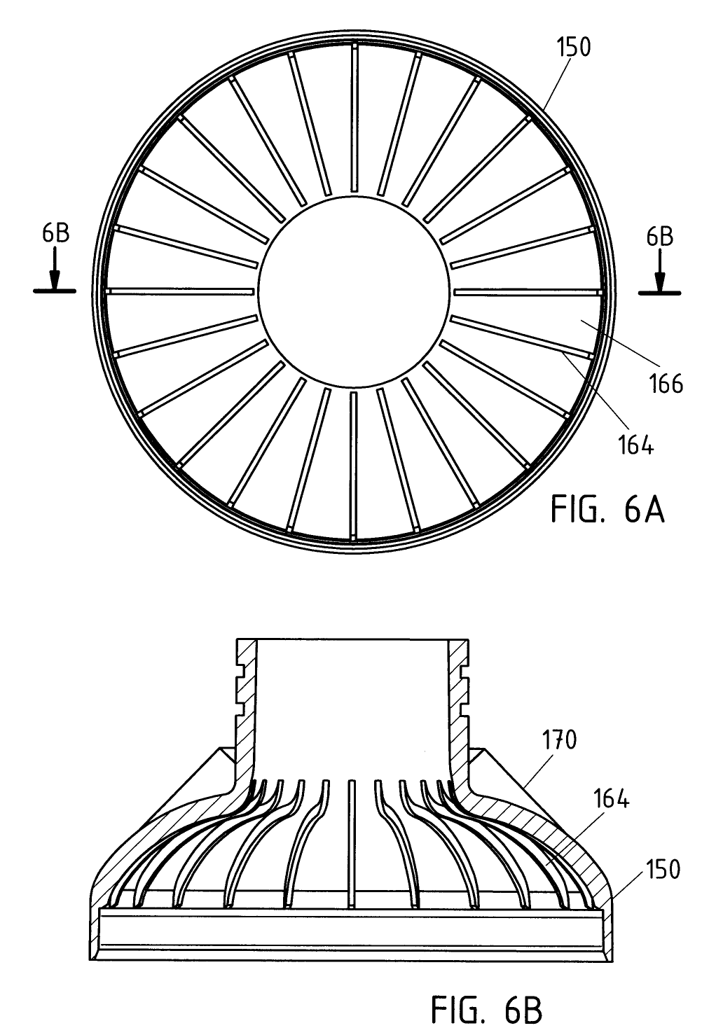

Referring to FIGS. 6A, 6B, in one or more embodiments, the end cap device 150 includes a fixture device 168 therein to assist with placement of the membranes during assembly. In one or more embodiments, the fixture and/or end cap device can include filtrate gaps in an edge of the fixture to provide for easier flow of filtrate within the pressure housing. The pressure housing used may be sized for a single element, or alternative multiple elements may be located within a larger pressure housing. The end cap device facilitates such larger housings by simplifying the isolation of feed and filtered water.

A method for forming a filtration assembly is further disclosed herein. The method includes placing an end cap device on a module to form a module assembly. Potting material is inserted. In general, the end cap device is assembled on both ends of ceramic membrane sections. The end cap device includes the various end cap devices described above. In one or more embodiments, these are loaded into a potting machine where the fixtured ends and fixtures are encased in potting material. The parts are allowed to set in the potting material, once set the endcaps are applied to the potted membrane sections. Numerous methods of joining that could be employed include, but are not limited to one or more of gluing, spin bonding, potting, welding, friction fit with gaskets, etc.

The membrane assembly provides a method sealing the feed/concentrate from the permeate. The assembly facilitates the ease of element assembly, and fixtures the element pieces together, helps control temperature expansion and will facilitate the use of drop in elements in standard housing. The end cap device holds the plates in place during potting, contains potting material during potting, and helps control the contraction and expansion when a predetermined thermoplastic and fill material are used. In addition, the end cap device provides a place to hold a seal and provides a sealing surface. Still further, the end cap device accommodates conical sealing. The material used for the end cap device can be chosen from a variety of materials, including, but not limited to PVC, CPVC, Ceramic, stainless steel, Duplex stainless steel, Hast alloy, Titanium, Filled thermoplastics, Thermoplastics, Composite materials, Aluminum, or coated metals, alone or in combination.

The end cap assembly can be used with a fixture which aligns the ceramic membrane and allows it to be efficiently assembly and sealed. It offers the benefit of controlling expansion and contraction and facilitates external sealing of the membrane element to the wall of the housing in which it operates. The sealing used to separate the streams overcomes inner diameter tolerance issues in standard housings. The end cap assembly and fixture can be joined together using a variety of methods. For example, the methods include, but are not limited to snap fit with an elastomeric seal, solvent bonding, adhesive, thermal bonding or welding, or sonic welding.

The embodiments have been described in detail with particular reference to certain embodiments thereof, but it will be understood that variations and modifications can be effected within the scope of the embodiments, especially to those skilled in the art. It should be noted that embodiments or portions thereof discussed in different portions of the description or referred to in different drawings can be combined to form additional embodiments of the present invention. The scope of the invention should, therefore, be determined with reference to the appended claims, along with the full scope of equivalents to which such claims are entitled.

What is claimed is:

1. A filtration assembly comprising:
at least one ceramic membrane assembly configured to be disposed within a housing, the at least one ceramic membrane assembly includes a membrane and at least one end cap device;
the membrane extending from a first membrane end to a second membrane end;
the end cap device disposed at the first membrane end of the membrane;
the end cap device is defined in part by a longitudinal axis and extends from a first end to a second end along the longitudinal axis, the end cap device defined in part by an inner surface and an outer surface, the end cap having an end port at the first end;
the end cap device includes an intermediate profile between the first end and the second end, the inner surface having a domed shape at the intermediate profile; and
the first end of the end cap device has a smaller inner diameter than the second end.

2. The filtration assembly as recited in claim 1, wherein the intermediate profile further includes an inflective curve that transitions the domed shape to the second end of the end cap device.

3. The filtration assembly as recited in claim 1, wherein the intermediate profile has a conical shape.

4. The filtration as recited in claim 3, wherein the intermediate profile extends from a first conical end to a second conical end, and the conical shape has a height A, extending from the first conical end to the second conical end 255, at the first conical end is an inner diameter C, and at the second conical end 255 is an inner diameter B, wherein the end cap device is sized as follows:
(B²/C²)*6x≈A, where x≧1.

5. The filtration assembly as recited in any one of claims 1-4, wherein the filtration assembly includes two end cap devices disposed at each end of the membrane.

6. The filtration assembly as recited in any one of claims 1-5, further comprising inner fins disposed along the inner surface of the end cap device, the inner fins having channels therebetween.

7. The filtration assembly as recited in any one of claims 1-6, further comprising ribs disposed along the outer surface of the end cap device.

8. A filtration assembly comprising:
a housing;
at least one ceramic membrane assembly disposed within the housing, the at least one ceramic membrane assembly includes a membrane and at least one end cap device;
the membrane extending from a first membrane end to a second membrane end;
a first end cap device disposed at the first membrane end of the membrane and a second end cap device disposed at the second end of the membrane;
each end cap device is defined in part by a longitudinal axis and extends from a first end to a second end along the longitudinal axis, the end cap device defined in part by an inner surface and an outer surface, each end cap having an end port at the second end;
the end cap device includes an inflection portion between the first end and the second end; and
the first end of the end cap device has a smaller inner diameter than the second end.

9. The filtration assembly as recited in claim 8, further comprising ribs disposed along the outer surface of the end cap device.

10. The filtration assembly as recited in any one of claims 8-9, wherein L is an overall length of the end cap device and D is an internal diameter of the first end of the end cap device, and a ratio of L to D is in the range of 1.5-5.1.

11. The filtration assembly as recited in any one of claims 8-10, wherein the inflection portion connects the first end to the second end.

12. The filtration assembly as recited in any one of claims 8-11, wherein the end cap device includes a first radius near the first end, and a second radius near the second end, and the first radius is not equal to the second radius.

13. The filtration assembly as recited in any one of claims 8-12, wherein the filtration assembly includes two end cap devices disposed at each end of the membrane.

14. The filtration assembly as recited in any one of claims 8-13, further comprising one or more fins on the internal surface of the end cap device.

15. The filtration assembly as recited in claim 8, further comprising ribs disposed along the outer surface of the end cap device, and one or more fins on the internal surface of the end cap device, where the ribs are offset from the fins.

16. The filtration assembly as recited in claim 15, wherein a total number of fins is half to two times a total number of ribs.

17. The filtration assembly as recited in any of claims 8-16, further comprising a water tight seal formed inside the end cap device at the second end between the end cap device and the membrane, and a second water tight seal is formed at an exterior surface of the first end 152 of the end cap device, configured to isolate clean water from dirty water within the filtration assembly.

18. A method for making a filtration assembly, the method comprising:
placing at least one end cap device on an end of a membrane assembly, the end cap device defined in part by a longitudinal axis and extends from a first end to a second end along the longitudinal axis, the end cap device defined in part by an inner surface and an outer surface, the end cap having an end port at the second end, the end cap device includes an inflection portion between the first end and the second end;
sealing the end cap device to the membrane assembly; and
potting the membrane assembly.

19. The method as recited in claim 18, wherein placing at least one end cap device includes placing a first end cap at a first membrane assembly end and placing a second end cap at a second membrane assembly end.
